(19) United States
(12) Patent Application Publication
(10) Pub. No.: US 2015/0026036 A1
(43) Pub. Date: Jan. 22, 2015

(54) SYSTEMS AND METHODS FOR MICRO-FACTORING AN INVOICE

(71) Applicant: Payscape Advisors, Atlanta, GA (US)

(72) Inventor: Adam Bloomston, Atlanta, GA (US)

(21) Appl. No.: 14/316,830

(22) Filed: Jun. 27, 2014

Related U.S. Application Data
(60) Provisional application No. 61/847,734, filed on Jul. 18, 2013.

(51) Int. Cl. G06Q 40/02; G06Q 20/14

(52) U.S. Cl. CPC G06Q 40/025; G06Q 20/14
USPC 705/38

(57) ABSTRACT

Systems and methods for micro-factoring an invoice are provided. A method is disclosed that includes receiving an invoice from a seller to a buyer, wherein the invoice includes an invoice amount; determining an advance amount using the invoice amount and a credit grade of the seller, wherein the advance amount is less than the invoice amount; sending, from the computer, to a payment gateway, at a first time, the advance amount to the seller; receiving, at the computer, from the payment gateway, at a second time, a payment of the invoice amount from the buyer, wherein the second time is greater than the first time; in response to receiving the payment of the invoice amount from the buyer, determining a remainder payment using the invoice amount and the advance amount; and sending, from the computer, to the payment gateway, the remainder payment to the seller.

### CROSS-REFERENCE TO RELATED APPLICATION

This application claims priority under 35 U.S.C. §119(e) to U.S. Provisional Application No. 61/847,734, entitled “Systems and Methods for Micro-Factoring an Invoice,” filed Jul. 18, 2013, the contents of which are hereby incorporated by reference as if fully set forth herein in full.

### BACKGROUND

An electronic accounting system facilitates the processing of a financial transaction. Electronic accounting systems have become increasingly popular due to the widespread use of on-line banking. Many types of businesses from Fortune 500 companies to brick-and-mortar shops use electronic accounting systems to manage their financial transactions. In general, an electronic accounting system may use an invoice to collect payment information for an electronic payment and may send the electronic payment to a payment gateway such as an on-line bank. Further, the payment gateway may process the electronic payment through its system or a third party's system to validate and authorize the payment. Once processed, the electronic payment may proceed towards settlement by charging the buyer and providing funds to the seller. However, the receipt of funds by the seller may be delayed or may result in a partial payment or no payment of funds by the buyer. Further, the terms of payment may allow for delaying payment for a period of time without penalty, e.g. net 30 days. In these situations, the seller's business operations may be impacted due to reduced cash flow. To mitigate the impact, the seller may seek a traditional business loan. Alternatively, the seller may use factoring to accelerate cash flow by paying the seller based on invoices received from qualified buyers. However, factoring has been traditionally used by established businesses and is typically a manual process that results in further processing delays. In addition, factoring has been predominantly used for business-to-business transactions. Accordingly, there is a need for techniques to improve factoring an invoice. Furthermore, other desirable features and characteristics of the present disclosure may become apparent from the subsequent detailed description and claims, taken in conjunction with the accompanying figures and the foregoing technical field and background.

### SUMMARY OF THE DISCLOSURE

The subject innovation relates to methods, devices, systems, or articles of manufacture for micro-factoring an invoice. According to one aspect, a method may include receiving, at a computer, from an accounting system, an invoice from a seller to a buyer. The invoice may include an invoice amount. The method may include determining an advance amount using the invoice amount and a credit grade of the seller. The advance amount may be less than the invoice amount. Further, the method may include sending, from the computer, to a payment gateway, at a first time, the advance amount to the seller. The method may include receiving, at the computer, from the payment gateway, at a second time, a payment of the invoice amount from the buyer. The second time may be greater than the first time. In response to receiving the payment of the invoice amount from the buyer, the method may include determining a remainder payment using the invoice amount and the advance amount. Also, the method may include sending, from the computer, to the payment gateway, the remainder payment to the seller.

In another aspect, a system may include a memory configured to store data and computer-executable instructions. Further, the system may include a processor operatively coupled to the memory. The processor and memory may be configured to receive, from an accounting system, an invoice from a seller to a buyer. The invoice may includes an invoice amount. Further, the processor and memory may be configured to determine an advance amount using the invoice amount and a credit grade of the seller. The advance amount may be less than the invoice amount. The processor and memory may be configured to send, to a payment gateway, at a first time, the advance amount to the seller. Also, the processor and memory may be configured to receive, from the payment gateway, at a second time, a payment of the invoice amount from the buyer. The second time may be greater than the first time. In response to receiving the payment of the invoice amount from the buyer, the processor and the memory may be configured to determine a remainder payment using the invoice amount and the advance amount. In addition, the processor and the memory may be configured to send, to the payment gateway, the remainder payment to the seller.

In another aspect, a non-transitory computer-readable medium may be encoded with a computer program. The computer program may include computer-executable instructions that when executed by a processor may cause the processor to perform operations. The operations may be configured to receive, from an accounting system, an invoice from a seller to a buyer. The invoice may include an invoice amount. Further, the operations may be configured to determine an advance amount using the invoice amount and a credit grade of the seller. The advance amount may be less than the invoice amount. Also, the operations may be configured to send, to a payment gateway, at a first time, the advance amount to the seller and may receive, from the payment gateway, at a second time, a payment of the invoice amount from the buyer. The second time may be greater than the first time. In response to receiving the payment of the invoice amount from the buyer, the operations may be configured to determine a remainder payment using the invoice amount and the advance amount. In addition, the operations may be configured to send, to the payment gateway, the remainder payment to the seller.

### BRIEF DESCRIPTION OF THE FIGURES

The present disclosure is illustrated by way of examples, embodiments and the like and is not limited by the accompanying figures, in which like reference numbers indicate similar elements. Elements in the figures are illustrated for simplicity and clarity and have not necessarily been drawn to scale. The figures along with the detailed description are incorporated and form part of the specification and serve to further illustrate examples, embodiments and the like, and explain various principles and advantages, in accordance with the present disclosure, where:

FIG. 1 illustrates one embodiment of a system for micro-factoring an invoice with various aspects described herein.

FIG. 2 is a flow chart illustrating one embodiment of a method for micro-factoring an invoice with various aspects described herein.

FIG. 3 is a flow chart illustrating another embodiment of a method for micro-factoring an invoice with various aspects described herein.

FIG. 4 is a block diagram of an illustrative computing system 400, according to an example implementation of the disclosed technology.

### DETAILED DESCRIPTION

This disclosure provides example methods, devices, systems, or articles of manufacture for micro-factoring an invoice. In one example, a seller may complete a micro-factoring application on a web page hosted by a computer. The computer may then send the completed application to an underwriter using an underwriting gateway for underwriting. Once approved, the computer may receive and use the approved application to determine a credit limit, an advance amount, interest rates, maximum invoice amount, average invoice amount, average amount per buyer, fees and the like. The credit limit, the advance amount, the fees and the like may then be used for processing electronic invoices of the seller. The seller may enter an invoice into an electronic accounting system. The computer may then receive the invoice from the electronic accounting system and review the invoice based on the maximum invoice amount, the average invoice, the maximum amount of funding per buyer and the like. The computer may then send the advance amount of the invoice to the seller using a payment gateway, thereby reducing the advance amount available to the seller. The seller may then use the advance amount to further operate the seller's business. At a later time, the buyer may make a payment of the invoice to the seller using an account that the computer has access to using the payment gateway. The computer may receive the payment of the invoice using the payment gateway and may send a remainder amount of the invoice to the seller using the payment gateway. The remainder amount may include the invoice amount minus the advance amount and all fees, thereby increasing the advance amount available to the seller.

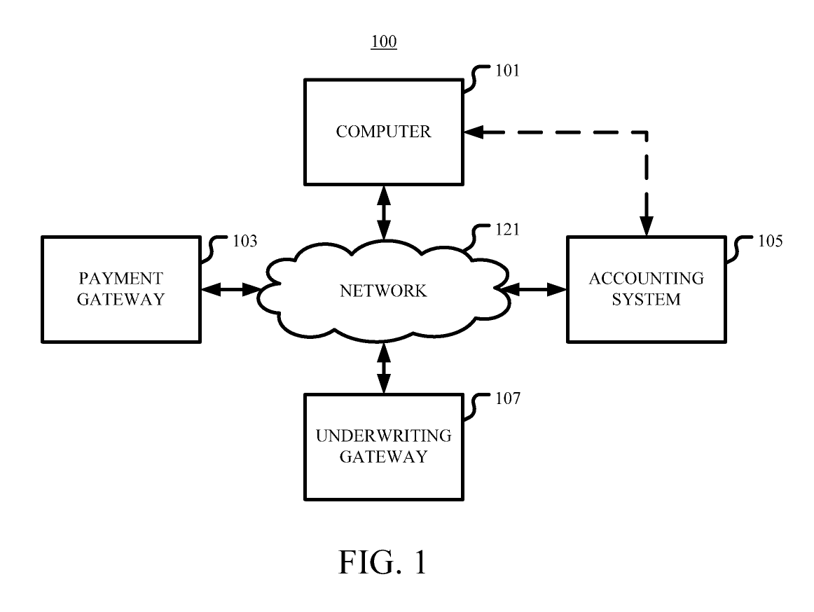

FIG. 1 illustrates one embodiment of a system 100 for micro-factoring an invoice with various aspects described herein. In FIG. 1, the system 100 may be configured to include a computer 101, a payment gateway 103, an accounting system 105 and an underwriting gateway 107, all of which may be operationally coupled to a network 121. The computer 101 may be configured to include a processor operatively coupled to memory. The computer 101 may process computer instructions and data stored in the memory. Also, the computer 101 may execute one or more services. The computer 101 may include one more computer programs running to serve requests or provide data to local computer programs executing on the computer 101 or remote computer programs executing on another computer. The computer 101 may be capable of performing functions associated with a server such as a database server, a file server, a mail server, a print server, a web server or the like, whether in hardware or software. In one example, the computer 101 may be a web server. The computer 101 may be configured to process requests or provide data to other computers over the network 121. The computer 101 may receive an application from a seller to allow the seller to access and use the services associated with the computer 101.

In FIG. 1, the computer 101 may submit the application of the seller to the underwriting gateway 107 using the network 121. The network 121 may encompass wired and wireless communication networks such as a local-area network (LAN), a wide-area network (WAN), a computer network, a wireless network, a telecommunications network, another like network or any combination thereof. The computer 101 may receive information over the network 121 from, for instance, the payment gateway 103, the accounting system 105, the underwriting gateway 107, or the like using a secure connection such as a cryptographic protocol that provides communication security over the Internet. In one example, the secure connection may use the transport layer security (TLS) protocol, the secure sockets layer (SSL) protocol, or the like. In another example, the secure connection may use a two hundred and fifty-six (256) bit SSL protocol.

In FIG. 1, an underwriter may access the application from the underwriting gateway 107 and assess the eligibility of the seller to receive credit. The underwriter may underwrite the seller, a principle of the seller, an invoice of the seller or the like. In one definition, an invoice may be a commercial document issued by a seller to a buyer, indicating a product or a service that the seller has or may provide the buyer. An invoice may also be referred to as a bill or a receivable item. The underwriter may underwrite the seller. Further, the underwriter may use criteria similar to those used to underwrite a working capital loan or a cash advance to underwrite the seller. Once the application of the seller is approved, the underwriter may send the approved application to the computer 101 using the underwriting gateway 107. The application of the seller may be approved by the underwriter based on, for instance, credit scores that use standard industrial classification (SIC) codes, or personal or business credit information.

In the current embodiment, the computer 101 may apply a credit grade to the seller based on the approved application from the underwriter. The credit grade may include a credit grade factor and a credit limit. The credit grade factor may include a credit percentage and a fee. The credit percentage may be the percentage used to determine the advance amount of the invoice amount of each invoice. The credit percentage may be adjusted based on the credit worthiness of the seller. Further, the credit percentage may be adjusted based on the credit worthiness of the buyer. The credit percentage may derive from historical industry metrics as they relate to the aging of invoices or accounts receivable of the seller or the buyer. In one example, the advance amount may be associated with sixty percent (60%) of an invoice amount for a seller or a buyer that receives a low credit grade. In another example, the advance amount may be associated with ninety percent (90%) of an invoice amount for a seller or a buyer that receives a high credit grade. The fee may be the amount the seller pays for the advance amount paid by the computer 101. In one example, the fee may be the amount the seller may pay per month until the invoice has been paid in full. In another example, the fee may be between about two percent (2%) and about four percent (4%) of the invoice amount, paid on a monthly basis by the seller. The credit limit may operate similar to the operation of a credit limit associated with a credit card. In one example, the computer 101 may automatically loan the advance amount of an approved invoice to the seller until the credit limit is reached or exceeded. Further, once the credit limit is reached or exceeded, the computer 101 may automatically decline an invoice of the seller. The computer 101 may decline an invoice of the seller until, for instance, a previously submitted invoice is paid or there is sufficient available credit. The computer 101 may also decline an invoice for a buyer that has a history of being deficient in their payments.

In FIG. 1, the seller may invoice a buyer using the accounting system 105. The accounting system 105 may be an electronic accounting system, an electronic invoicing system, or a system capable of electronic billing, electronic bill payment, or electronic bill presentment. The computer 100 may then receive the invoice from the accounting system 105. The computer 101 may then send the advance amount of the invoice amount of the invoice to the seller using the payment gateway 103. In one example implementation, the payment gateway 103 may be an active service that authorizes payments for e-businesses, online retailers, traditional brick and mortar businesses or may be equivalent to a point of sale (POS) terminal. According to an example embodiment of the disclosed technology, the payment gateway 103 may utilize one or more of PHP, ColdFusion, Ruby, ASP and/or the like for implementation. In certain example implementations, the payment gateway 103 may protect payment information by encrypting sensitive information, such as credit card numbers. The computer 101 may receive from the buyer a payment of the invoice amount using the payment gateway 103. Any payments of the invoice amount of the invoice by the buyer to the seller may be directed through a bank account associated with and accessible by the computer 101 using the payment gateway 103. The bank account associated with and accessible by the computer 101 using the payment gateway 103 may be capable of accepting payments using a credit card, an electronic check (Echeck), or the like. Further, the bank account associated with and accessible by the computer 101 using the payment gateway 103 may maintain a “lock box” service. In response to receiving the payment of the invoice amount, the computer 101 may send, to the bank account of the seller using the payment gateway 103, a remainder amount of the invoice amount of the invoice. The remainder amount may be the invoice amount minus the advance amount and any fees including any accrued interest, processing fees or the like.

In this embodiment, the computer 101 may maintain a profile in a database of each seller. Each profile may include account information such as a monthly available funding limit, a fee schedule, an interest rate, an interest method, any applicable fees associated with factoring of receivables, and the like. Further, each profile may also contain a unique identifier to allow an external system such as the accounting system 105 or the payment gateway 103 to authenticate or transfer information to or from the computer 101. Once an invoice has been transferred from the accounting system 105 to the computer 101, the accounting system 105 may modify its associated collection account to forward any collections to the payment gateway 103 using the computer 101. After the invoice has been received and approved by the computer 101, the computer 101 may then send the advance amount of the invoice amount of the invoice to the seller using the payment gateway 103. Further, the computer 101 may reduce the total available credit amount available to the seller. The invoice is now funded by the computer 101 and may be referred to as a funded invoice. The computer 101 may include an age, a life cycle, or the like for each funded invoice. In one example, the life cycle may be based on the date the invoice was funded. In another example, the life cycle may be based on the data the invoice was transferred from the accounting system 105 to the computer 101. In another example, the life cycle may be based on a calendar billing cycle.

In FIG. 1, once the invoice is received from the accounting system 105, the computer 101 may transfer the advance amount of the invoice amount of the invoice to a bank account of the seller using the payment gateway 103. Further, the computer 101 may reduce the total available credit amount of the seller. The computer 101 may store a seller profile for each seller, which may include the advance amount of the invoice amount of the invoice, the invoice amount of the invoice, the invoice, the credit percentage, the total credit amount available, bank account information, or the like. If the seller has used the total credit amount available, then the computer 101 may decline a request by the seller of new funding until, for instance, payments for some of the funded invoices have been collected.

In this embodiment, after the computer 101 has received a payment associated with the funded invoice, the computer 101 may determine the age of the funded invoice. The computer 101 may use the age of the funded invoice to complete the funding of the funded invoice. The computer 101 may complete the funding of the funded invoice by sending to the seller using the payment gateway 103 a remainder amount of the invoice. The computer 101 may determine the remainder amount of the invoice by using, for instance, the invoice amount of the invoice, the advance amount of the invoice, interest, a processing fee, or the like. In one example, the remainder amount of the invoice may be the invoice amount of the invoice minus the advance amount of the invoice, prorating monthly percentage rate to a daily amount and a processing fee. A person of ordinary skill in the art will recognize that there are many different methods used to determine interest. After the remainder amount of the invoice is transferred from the computer 101 to the bank account of the seller using the payment gateway 103, the computer 101 may increase the total available credit amount of the seller by the remainder amount.

In FIG. 1, the computer 101 may determine that the funded invoice is not paid by the buyer within the age limit, as defined in the seller profile of the seller. In response, the computer 101 may no longer attempt to collect payment from the buyer for the funded invoice. Further, the computer 101 may return the funded invoice to the seller. For a returned funded invoice, the computer 101 may add an aging fee based on the age of the funded invoice. In this case, the computer 101 may determine the remainder amount of the invoice based on, for instance, the invoice amount of the invoice, the advance amount of the invoice, interest, a processing fee, an aging fee, or the like. In one example, the computer 101 may determine that the remainder amount is the advance amount of the invoice minus the interest, the processing fee, and the aging fee. Further, the computer 101 may collect all or any portion of the remainder amount from any payments from the buyer to the seller received by the computer 101 using the payment gateway 103. Also, the computer 101 may collect all or any portion of the remainder amount from all or any portion of an advance amount of an invoice amount of another invoice of the seller. In the event that a seller has no available credit amount or payments from any buyers available, the computer 101 may recover all invoice fees directly from the seller's bank account using the payment gateway 103.

In another embodiment, the functions performed by the computer 101 may be integrated with the accounting system 105. In one example, the functions performed by the computer 101 may be integrated with the accounting system 105 using an application programming interface (API). In another example, the functions performed by the computer 101 may be integrated with and form a portion of the accounting system 105.

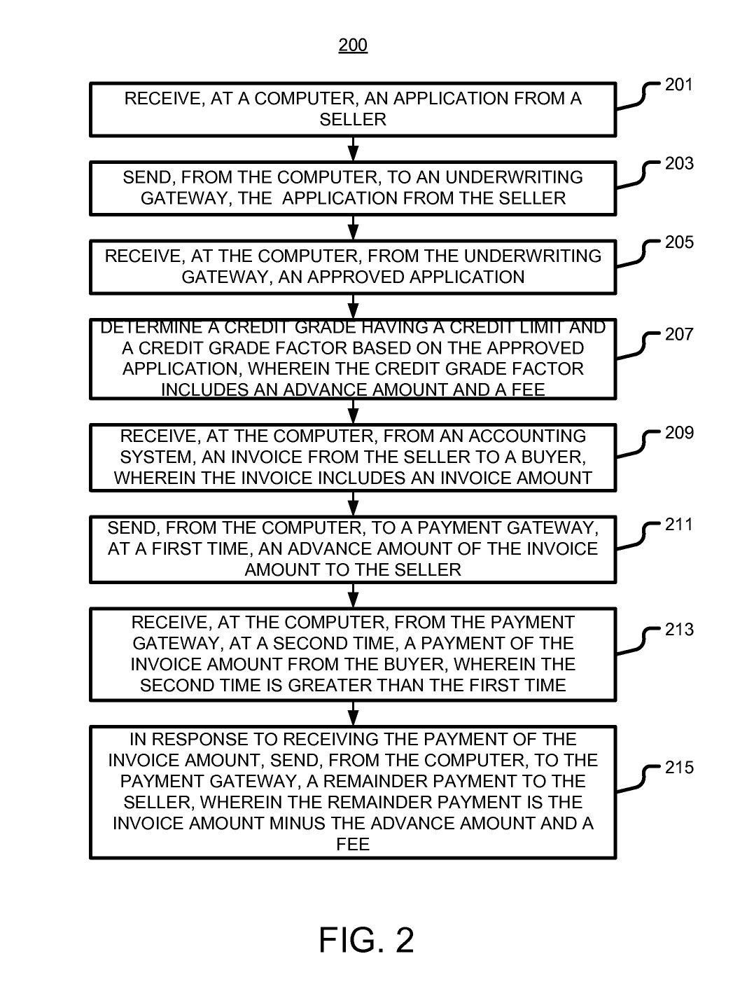

FIG. 2 is a flow chart illustrating one embodiment of a method 200 for micro-factoring an invoice with various aspects described herein. In FIG. 2, the method 200 may begin at, for instance, block 201, where it may receive, at a computer, a micro-factoring application from a seller. At block 203, the method 200 may send, from the computer, to an underwriter, the micro-factoring application from the seller. At block 205, the method 200 may receive, at the computer, from the underwriter, an approved micro-factoring application. At block 207, the method 200 may determine a credit limit and a credit grade factor based on the approved micro-factoring application. The credit grade factor may include an advance amount and a monthly fee. At block 209, the method 200 may receive, at the computer, from an accounting system, an invoice from the seller to a buyer. The invoice may include an invoice amount to be paid by the buyer to the seller. At block 211, the method 200 may send, from the computer, to a payment gateway, at a first time, the advance amount of the invoice amount to the seller. At block 213, the method 200 may receive, at the computer, from the payment gateway, at a second time, a payment of the invoice amount from the buyer. The second time may be greater than the first time. In one example, the second time is greater than the first time by one or more days. At block 215, the method 200 may send, from the computer, to the payment gateway, a reminder payment to the seller. The remainder amount may be the invoice amount minus the advance amount and a fee.

In another embodiment, the method 200 may be integrated with an accounting system. In one example, the method 200 may be performed by the accounting system using an API. In another example, the method 200 may be integrated with and form a portion of the accounting system.

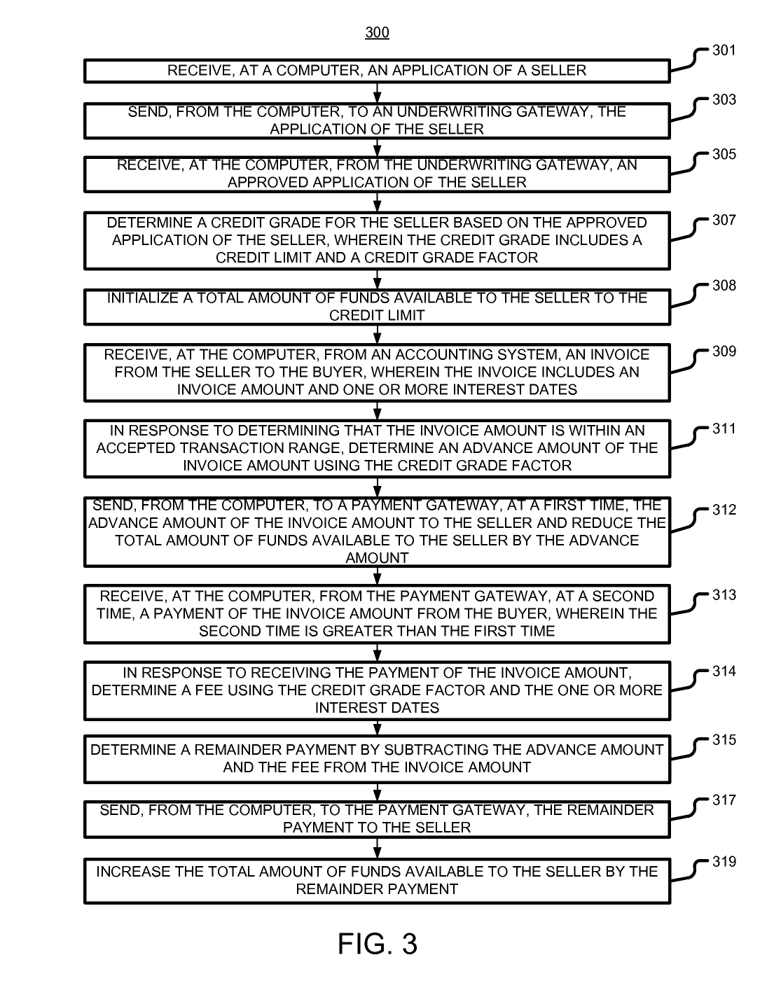

FIG. 3 is a flow chart illustrating another embodiment of a method 300 for micro-factoring an invoice with various aspects described herein. In FIG. 3, the method 300 may begin at, for instance, block 301, where it may include receiving, at a computer, an application of a seller. At block 303, the method 300 may include sending, from the computer, to an underwriting gateway, the application of the seller. At block 305, the method 300 may include receiving, at the computer, from the underwriting gateway, an approved application of the seller. At block 307, the method 300 may include determining a credit grade for the seller based on the approved application of the seller. The credit grade may include a credit limit and a credit grade factor. At block 308, the method 300 may include initializing a total amount of funds available to the seller to the credit limit. At block 309, the method 300 may include receiving, at the computer, from an accounting system, an invoice from the seller to the buyer. The invoice may include an invoice amount and one or more interest dates. In response to determining that the invoice amount is within an accepted transaction range, at block 311, the method 300 may include determining an advance amount of the invoice amount using the credit grade factor.

In FIG. 3, at block 312, the method 300 may send, from the computer, to a payment gateway, at a first time, the advance amount of the invoice amount to the seller and reduce the total amount of funds available to the seller by the advance amount. At block 313, the method 300 may include receiving, at the computer, from the payment gateway, at a second time, a payment of the invoice amount from the buyer. The second time may be greater than the first time. In response to receiving the payment of the invoice amount, at block 314, the method 300 may include determining a fee using the credit grade factor and the one or more interest dates. At block 315, the method 300 may include determining a remainder payment by subtracting the advance amount and the fee from the invoice amount. At block 317, the method 300 may include sending, from the sever, to the payment gateway, the remainder payment to the seller. At block 319, the method 300 may include increasing the total amount of funds available to the seller by the remainder payment.

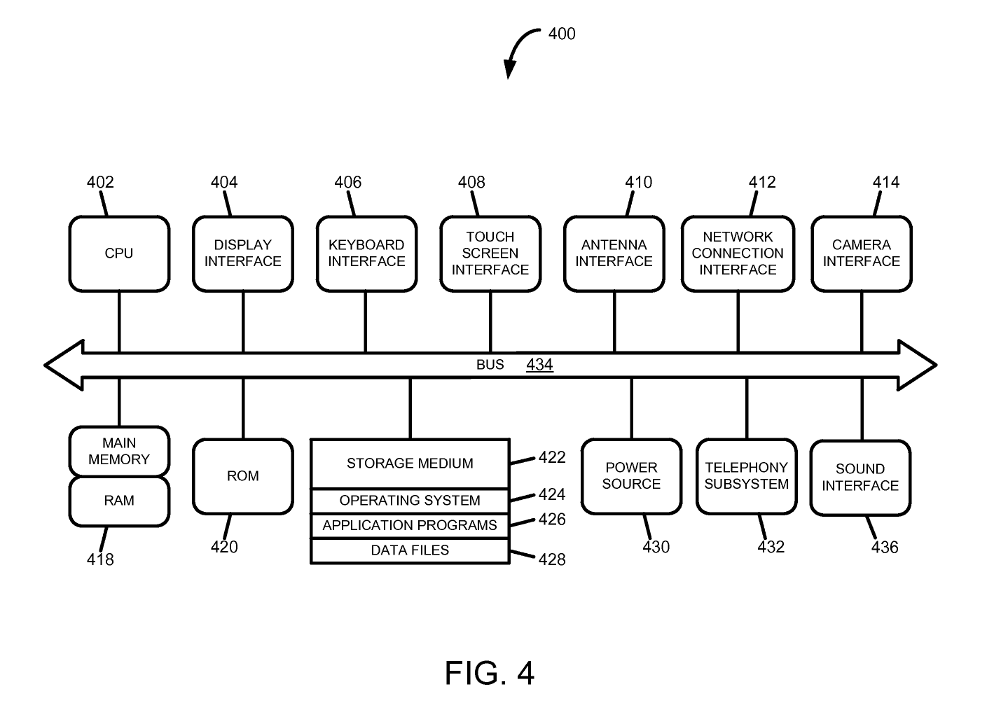

FIG. 4 is block diagram of an illustrative computing device 400, according to an example implementation of the disclosed technology. In an example implementation, the computing device 400 may be embodied as the computer 101, as shown in FIG. 1. In certain example implementations, the computing device 400 may represent one or more of the payment gateway 103, the accounting system 105, and/or the underwriting gateway 107, as shown in FIG. 1.

The computing device 400 of FIG. 4 includes a central processing unit (CPU) 402, where computer instructions are processed; a display interface 404 that acts as a communication interface and provides functions for rendering video, graphics, images, and texts on the display. In certain example implementations of the disclosed technology, the display interface 404 may be directly connected to a local display, such as a touch-screen display associated with a mobile computing device. In another example implementation, the display interface 404 may be configured for providing data, images, and other information for an external/remote display that is not necessarily physically connected to the computing device. For example, a desktop monitor may be utilized for mirroring graphics and other information that is presented on the computing device 400. In certain example implementations, the display interface 404 may wirelessly communicate, for example, via a Wi-Fi channel or other available network connection interface 412 to the external/remote display.

In an example implementation, the network connection interface 412 may be configured as a communication interface, for example, to provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device 400 may include a keyboard interface 406 that provides a communication interface to a keyboard. In one example implementation, the computing device 400 may include a pointing device or touch screen interface 408. According to certain example implementations of the disclosed technology, the pointing device or touch screen interface 408 may provide a communication interface to various devices such as a pointing device, a touch screen, a depth camera, etc. which may or may not be associated with a display.

The computing device 400 may be configured to use an input device via one or more of input/output interfaces (for example, the keyboard interface 406, the display interface 404, the display interface 408, network connection interface 412, camera interface 414, sound interface 416, etc.,) to allow a user to capture information into the computing device 400. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor such as an accelerometer or gyroscope, a smartcard, and the like. Additionally, the input device may be integrated with the computing device 400 or may be a separate device.

Example implementations of the computing device 400 may include an antenna interface 410 that provides a communication interface to an antenna; a network connection interface 412 that provides a communication interface to a network. In certain implementations, a camera interface 414 may be provided for capturing digital images, for example, from a camera. In certain implementations, a sound interface 416 may be provided as a communication interface for converting sound into electrical signals using a microphone and for converting electrical signals into sound using a speaker. According to example implementations, a random access memory (RAM) 418 is provided, where computer instructions and data may be stored in a volatile memory device for processing by the CPU 402.

According to an example implementation, the computing device 400 includes a read-only memory (ROM) 420 where invariant low-level system code or data for basic system functions such as basic input and output (I/O), startup, or reception of keystrokes from a keyboard are stored in a non-volatile memory device. According to an example implementation, the computing device 400 includes a storage medium 422 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 424, application programs 426 and data files 428 are stored. According to an example implementation, the computing device 400 includes a power source 430 that provides an appropriate alternating current (AC) or direct current (DC) to power components. According to an example implementation, the computing device 400 may include and a telephony subsystem 432 that allows the device 400 to transmit and receive sound over a telephone network. The constituent devices and the CPU 402 communicate with each other over a bus 434.

In accordance with an example implementation, the CPU 402 has appropriate structure to be a computer processor. In one arrangement, the computer CPU 402 may include more than one processing unit. The RAM 418 interfaces with the computer bus 434 to provide quick RAM storage to the CPU 402 during the execution of software programs such as the operating system application programs, and device drivers. More specifically, the CPU 402 loads computer-executable process steps from the storage medium 422 or other media into a field of the RAM 418 in order to execute software programs. Data may be stored in the RAM 418, where the data may be accessed by the computer CPU 402 during execution. In one example configuration, the device 400 includes at least 128 MB of RAM, and 256 MB of flash memory.

The storage medium 422 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 400 to access computer-executable process steps, application programs and the like, stored on removable and non-removable memory media, to off-load data from the device 400 or to upload data onto the device 400. A computer program product, such as one utilizing a communication system may be tangibly embodied in storage medium 422, which may comprise a machine-readable storage medium.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

The previous detailed description is merely illustrative in nature and is not intended to limit the present disclosure, or the application and uses of the present disclosure. Furthermore, there is no intention to be bound by any expressed or implied theory presented in the preceding field of use, background, or summary of the disclosure or the following detailed description. The present disclosure provides various examples, embodiments and the like, which may be described herein in terms of functional or logical block elements. Various techniques described herein may be used for micro-factoring an invoice. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware, or any combination thereof to control a computing device to implement the disclosed subject matter. The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art may recognize many modifications may be made to this configuration without departing from the scope or spirit of the claimed subject matter.

Throughout the specification and the claims, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or.” Further, the terms “a,” “an,” and “the” are intended to mean one or more unless specified otherwise or clear from the context to be directed to a singular form. The term “include” and its various forms are intended to mean including but not limited to.

In the previous description, numerous specific details are set forth. However, it is to be understood that embodiments of the disclosed technology may be practiced without these specific details. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may.

It is important to recognize that it is impractical to describe every conceivable combination of components or methodologies for purposes of describing the claimed subject matter. However, a person having ordinary skill in the art may recognize that many further combinations and permutations of the subject innovations are possible. Accordingly, the claimed subject matter is intended to cover all such alterations, modifications and variations that are within the spirit and scope of the claimed subject matter.

Although the present disclosure describes specific examples, embodiments, and the like, various modifications and changes may be made without departing from the scope of the present disclosure as set forth in the claims below. For example, although the example methods, devices, systems, or articles of manufacture described herein are in conjunction with micro-factoring an invoice, the skilled artisan may readily recognize that the example methods, devices, systems, or articles of manufacture may be used in other methods, devices, systems, or articles of manufacture and may be configured to correspond to such other example methods, devices, systems, or articles of manufacture as needed. Further, while at least one example, embodiment, or the like has been presented in the foregoing detailed description, many variations exist. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all of the claims. Any benefits, advantages, or solutions to problems that are described herein with regard to specific examples, embodiments, or the like are not intended to be construed as a critical, required, or essential feature or element of any or all of the claims.

What is claimed is:

1. A method, comprising:
receiving, at a computer, from an accounting system, an invoice from a seller to a buyer, wherein the invoice includes an invoice amount;
determining an advance amount using the invoice amount and a credit grade of the seller, wherein the advance amount is less than the invoice amount;
sending, from the computer, to a payment gateway, at a first time, the advance amount to the seller;
receiving, at the computer, from the payment gateway, at a second time, a payment of the invoice amount from the buyer, wherein the second time is greater than the first time;
in response to receiving the payment of the invoice amount from the buyer, determining a remainder payment using the invoice amount and the advance amount; and
sending, from the computer, to the payment gateway, the remainder payment to the seller.

2. The method of claim 1, further comprising:
determining the credit grade of the seller based on an approved application of the seller, wherein the credit grade includes a credit limit and a credit grade factor.

3. The method of claim 2, wherein the credit grade factor includes a credit percentage.

4. The method of claim 2, further comprising:
in response to sending an application of the seller, receiving, at the computer, from an underwriting gateway, an approved application of the seller.

5. The method of claim 4, further comprising:
receiving, at the computer, the application of the seller; and
sending, from the computer, to the underwriting gateway, the application of the seller.

6. The method of claim 2, further comprising:
initializing a total amount of funds available to the seller to the credit limit of the seller.

7. The method of claim 1, further comprising:
subtracting the advance amount from the invoice amount to determine the remainder payment.

8. The method of claim 1, further comprising:
determining a fee using the credit grade factor and one or more interest dates associated with the invoice.

9. The method of claim 8, further comprising:
subtracting the advance amount and the fee from the invoice amount to determine the remainder payment.

10. The method of claim 1, further comprising:
increasing a total amount of funds available to the seller by the remainder payment.

11. A system, comprising:
a memory configured to store data and computer-executable instructions; and
a processor operatively coupled to the memory, wherein the processor and memory are configured to:
receive, from an accounting system, an invoice from a seller to a buyer, wherein the invoice includes an invoice amount;
determine an advance amount using the invoice amount and a credit grade of the seller, wherein the advance amount is less than the invoice amount;
send, to a payment gateway, at a first time, the advance amount to the seller;
receive, from the payment gateway, at a second time, a payment of the invoice amount from the buyer, wherein the second time is greater than the first time;
in response to receiving the payment of the invoice amount from the buyer, determine a remainder payment using the invoice amount and the advance amount; and
send, to the payment gateway, the remainder payment to the seller.

12. The system of claim 11, wherein the processor and memory are further configured to:
determine the credit grade of the seller based on an approved application of the seller, wherein the credit grade includes a credit limit and a credit grade factor.

13. The system of claim 12, wherein the processor and memory are further configured to:
in response to sending an application of the seller, receive, from an underwriting gateway, the approved application of the seller.

14. The system of claim 13, wherein the processor and memory are further configured to:
receive the application of the seller; and
send, to the underwriting gateway, the application of the seller.

15. The system of claim 12, wherein the processor and memory are further configured to:
initialize a total amount of funds available to the seller to the credit limit of the seller.

16. The system of claim 11, wherein the processor and memory are further configured to:
subtract the advance amount from the invoice amount to determine the remainder payment.

17. The system of claim 12, wherein the processor and memory are further configured to:
determine a fee using the credit grade factor and one or more interest dates associated with the invoice.

18. The system of claim 17, wherein the processor and memory are further configured to:
subtract the advance amount and the fee from the invoice amount to determine the remainder payment.

19. The system of claim 11, wherein the processor and memory are further configured to:
increase a total amount of funds available to the seller by the remainder payment.

20. A non-transitory computer-readable medium encoded with a computer program, the computer program comprising computer-executable instructions that when executed by a processor causes the processor to perform operations, wherein the operations are configured to:
receive, from an accounting system, an invoice from a seller to a buyer, wherein the invoice includes an invoice amount;
determine an advance amount using the invoice amount and a credit grade of the seller, wherein the advance amount is less than the invoice amount;
send, to a payment gateway, at a first time, the advance amount to the seller;
receive, from the payment gateway, at a second time, a payment of the invoice amount from the buyer, wherein the second time is greater than the first time;
in response to receiving the payment of the invoice amount from the buyer, determine a remainder payment using the invoice amount and the advance amount; and
send, to the payment gateway, the remainder payment to the seller.
